(19) United States
(12) Patent Application Publication
(10) Pub. No.: US 2015/0014969 A1
(43) Pub. Date: Jan. 15, 2015

(54) AIRBAG DEVICE

(71) Applicant: HYUNDAI MOTOR COMPANY, SEOUL (KR)

(72) Inventor: Jun Yeol CHOI, SEOUL (KR)

(73) Assignee: HYUNDAI MOTOR COMPANY, SEOUL (KR)

(21) Appl. No.: 14/097,106

(22) Filed: Dec. 4, 2013

(30) Foreign Application Priority Data
Jul. 11, 2013 (KR) 10-2013-0081506

(51) Int. Cl. B60R 21/239

(52) U.S. Cl. CPC B60R 21/239
USPC 280/730.1; 280/743.1

(57) ABSTRACT

An airbag device may include a cushion each of both sides of which is formed with a vent hole through which introduced gas is discharged outside, a vent tether a front of which is connected to a front surface of the cushion and a rear of which is extended toward the vent hole inside the cushion, and a vent screen which is extended from the vent tether, connected to a rear of the vent hole and has a surface area for covering the vent hole. The vent screen is initially folded and upon being pulled by the vent tether when the cushion is deployed, is unfolded frontward to cover and close the vent hole. A force of the vent tether is decreased when the deployed cushion is compressed by a passenger, thereby opening the vent hole to discharge the gas.

### CROSS-REFERENCE TO RELATED APPLICATION

The present application claims priority of Korean Patent Application Number 10-2013-0081506 filed Jul. 11, 2013, the entire contents of which application is incorporated herein for all purposes by this reference.

### BACKGROUND OF INVENTION

1. Field of Invention

The present invention relates to an airbag device, and more particularly, to an airbag device, capable of preventing a passenger from being impacted when an airbag cushion is deployed initially, protecting the passenger from being impacted by keeping the pressure inside the airbag in a high pressure state when the airbag cushion is deployed fully, and minimizing damage to the passenger caused from the airbag by dampening the impact applying to the passenger and then keeping the pressure inside the airbag in a low pressure state by discharging the gas therein.

2. Background Art

Generally, safety devices have been provided in a vehicle in order to protect passenger safety from vehicle accidents such as a collision and overturning, and the safety devices include a safety belt for restraining a body of a passenger and an airbag for dampening impact caused from a collision to a vehicle body. This airbag may be mounted to various locations as needed, including a steering wheel as a driver's seat airbag and an instrument panel as a passenger's seat airbag.

Pressure of the airbag is controlled by discharging gas through a vent hole having a predetermined diameter; however, there are some difficulties to control the pressure of the airbag with the vent hole alone, and thus it is not sufficient to reduce the injury to a passenger.

That is, at an initial state of a collision of a vehicle, a gas inside an air cushion is to be lost at a minimum level to maintain a high pressure and thus the air cushion is swelled to fully protect passengers from impact. In addition, after the airbag restrains passengers, the gas inside the airbag is to be discharged outside to lower the pressure therein, and thus secondary injury caused from a deployment force of the air cushion has to be prevented.

Recently, in order to minimize a degree of the injury that can be caused as an airbag is deployed, an airbag of a lower risk deployment (LRD) has been developed, in which the gas inside the air cushion is to be discharged outside when a passenger sits near the airbag, to reduce the deployment force, thereby preventing an accident caused from the deployment of the airbag.

For this purpose, an active vent and a LRD vent to adjust selectively an opening/closing of a vent hole are provided in the airbag cushion to control pressure inside a chamber; however, in a case of the active vent, a motor for driving the active vent has to be installed, thereby increasing manufacturing cost and weight of the airbag. Furthermore, in a case of a conventional LRD vent, the vent hole is not opened/closed consistently, and further the airbag cushion is broken down due to the excessive internal pressure of the airbag cushion.

Accordingly, a need exists for an airbag device capable of improving LRD performance of an airbag, preventing the breaking down of the airbag cushion due to the excessive internal pressure of the airbag cushion, and absorbing efficiently energy.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with the related art.

Various aspects of the present invention provide for an airbag device, including: a cushion each of both sides of which is formed with a vent hole through which introduced gas is discharged outside; a vent tether a front of which is connected to a front surface of the cushion and a rear of which is extended toward the vent hole inside the cushion; and a vent screen which is extended from the vent tether, connected to a rear of the vent hole and has a surface area for covering the vent hole, wherein the vent screen is initially folded and upon being pulled by the vent tether when the cushion is deployed, is unfolded frontward to cover and close the vent hole, and a tension force of the vent tether is decreased when the deployed cushion is compressed by a passenger, thereby opening the vent hole to discharge the gas.

A screen guide may be formed at a perimeter of the vent hole in the cushion to fix the vent tether so as not to be moved to a direction other than a front/rearward direction. The screen guide may be formed to cover the vent hole and the vent screen wherein a hole having substantially the same diameter as the vent hole is formed and a front end thereof is opened for the vent tether to be moved front/rearward.

The vent tether may be extended frontwardly at a side of the vent hole to be connected to the front surface of the cushion and then extended rearwardly to be connected to a lower end of a rear surface of the cushion. A tether guide to which the vent tether is connected slidably may be provided to the front surface of the cushion and a length of the vent tether is controlled to vary as the vent tether is slid to the tether guide when the cushion is compressed after deployment. A front end of the vent tether may be connected to an upper front of the cushion to correspond to a head of the passenger when the cushion is deployed. A width of the vent tether may be narrower than that of the vent screen so that even when the vent tether is disposed within the vent hole while the vent screen is folded, a discharging space for the gas is ensured.

The vent screen may be temporarily folded in a zigzag shape. The vent screen may be inclined toward a center from a rear side to a front side so that a gap is formed between an inclined portion and the vent hole when the vent screen is unfolded frontward to cover the vent hole. A through hole may be formed corresponding to the vent hole when the vent screen is unfolded. The through hole formed in the vent screen may be formed to include a plurality of through holes within the periphery of the vent hole.

It is understood that the term “vehicle” or “vehicular” or other similar terms as used herein are inclusive of motor vehicles in general, such as passenger automobiles, sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are views showing an exemplary airbag device according to the present invention, respectively;

FIGS. 3 and 4 are views showing operation states of the airbag device as shown in FIG. 1, respectively;

FIGS. 5 to 7 are views showing a vent screen of the airbag device as shown in FIG. 1 is operated, respectively; and

FIGS. 8 and 9 are views showing varied vent screens of the airbag device as shown in FIG. 1, respectively.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

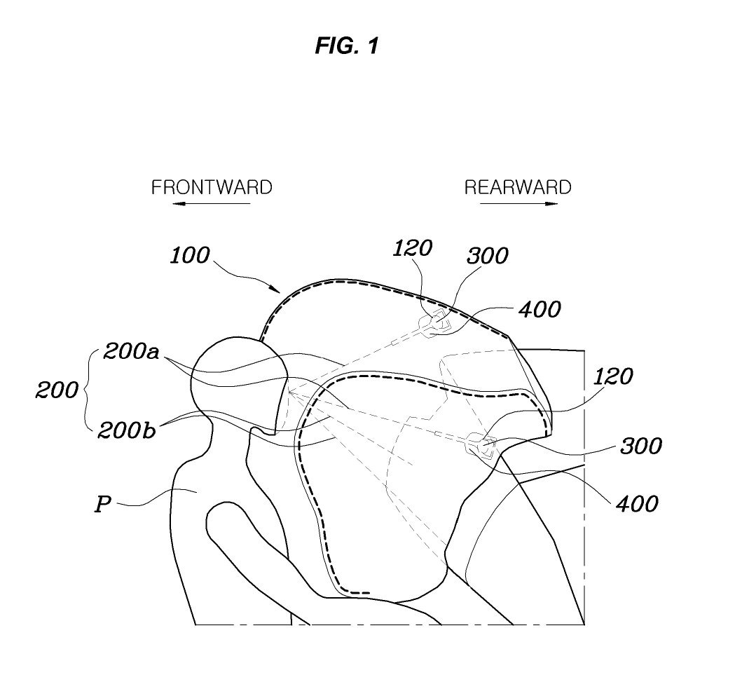

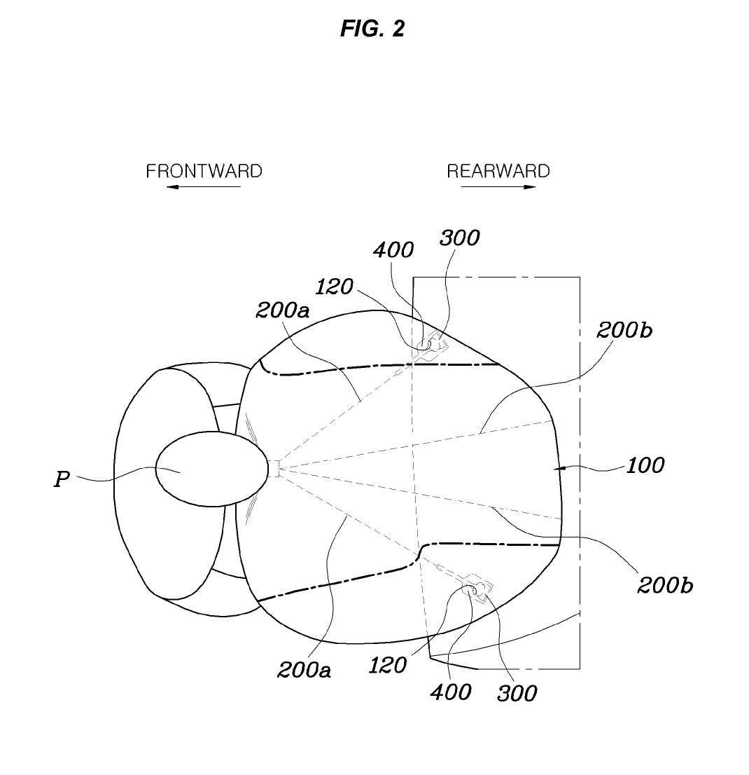

FIGS. 1 and 2 are views showing an airbag device according to various embodiments of the present invention. Referring to the drawings, an airbag device includes: a cushion 100 at both sides of which vent holes 120 through which introduced gas is discharged outside are formed, respectively; a vent tether 200 a front of which is connected to a front surface of the cushion 100 and a rear of which is extended toward the vent hole 120 inside the cushion 100; and a vent screen 300 which is extended from the vent tether 200 to be connected to a rear of the vent hole 120, is formed by being folded to have an area of a level to cover the vent hole 120, and is unfolded frontward to cover and close the vent hole 120, by being pulled by the vent tether 200 when the cushion 100 is deployed, and in which a tension force of the vent tether 200 is decreased when the deployed cushion 100 is compressed by a passenger P and the vent hole 120 is opened by the discharging gas.

Here, a general airbag is provided with an inflator for injecting gas into a cushion when a vehicle collides and a controller for transferring an explosion signal of the inflator, however, it is obvious and thus the description thereof is omitted.

The cushion 100 serves to dampen the impact that is transferred to a passenger when a vehicle is in a collision, at both sides of which the vent holes 120 through which the gas in the cushion is discharged are formed. Here, a location where the vent hole 120 is arranged may be designed variably depending on the types of vehicles wherein the vent hole may be formed to a rear, in addition to both sides of the cushion 100 to allow the gas to be ejected into a dashboard. Furthermore, the vent hole 120 may be provided as a plurality depending on the types of the vehicles and necessary internal pressure of the cushion, and the number of the vent holes may be varied depending on a design of the cushion.

Meanwhile, the vent tether 200 a front end of which is connected to a front of the cushion 100 and a rear end of which is extended toward a side of the vent hole 120 is provided inside the cushion 100. Here, the vent tether 200 is provided for giving tension to a vent screen 300, which will be described below, when the cushion 100 is deployed, and the vent tether 200 is pulled forward when the cushion 100 is deployed forward. The vent tethers 200 may be provided on an upper side and a lower side of the cushion, respectively.

The vent tether 200 may be extended frontwardly at a side of the vent hole 120 to be connected to a front surface of the cushion 100 and then extended back rearwardly to be connected to a lower end of a rear surface of the cushion 100.

Here, a tether guide 140 to which the vent tether 200 is connected slidably may be provided to a front surface of the cushion 100 such that when the cushion 100 is compressed after deployment, a length of the vent tether 200 can be controlled to vary as the vent tether 200 is slid to the tether guide 140.

In the present invention, the vent screen 300 is deployed by the vent tether 200 to cover and close the vent hole 120 when the cushion 100 is deployed, and a tension force of the vent tether 200 is decreased to open the vent hole 120 when the deployed cushion 100 is compressed. That is, when the passenger P compresses the cushion 100, the tension force of the vent tether 200 is decreased while the front and rear lengths of the vent tether 200 are shortened, to guide the vent hole 120 to be opened.

However, there may arise a problem in that the left and right widths of the cushion 100 are increased as the front surface of the cushion 100 is compressed by the passenger P and thus the length of the vent tether 200 cannot be shortened. As a result, the tension force of the vent tether 200 may not be decreased to keep a state at which the vent screen 300 closes the vent hole 120, and thus the gas inside the cushion 100 may not be discharged through the vent hole 120.

In order to prevent this phenomenon, the vent tether 200 is extended frontwardly at a side of the vent hole 120 to be connected to a front surface of the cushion 100 and extended back rearwardly to be connected to a lower end of a rear surface of the cushion 100. Here, the vent guide 140 to which the vent tether 200 is connected slidably is provided to a front surface of the cushion 100.

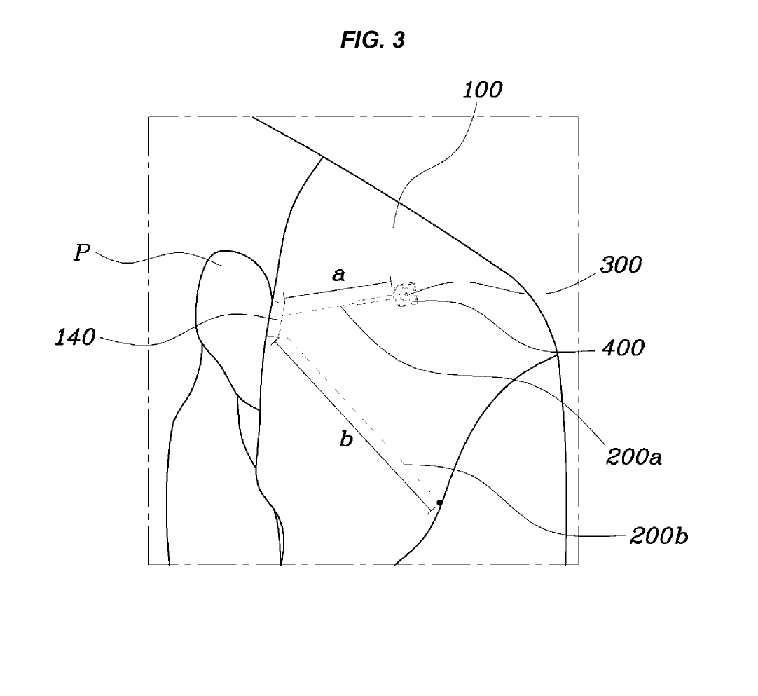

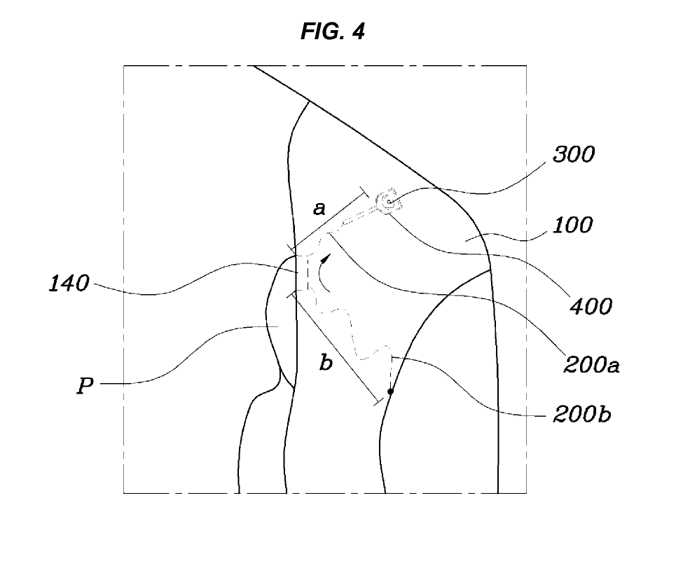

Referring to FIGS. 3 and 4, the vent tether 200 is disposed at an upper side of the cushion wherein the vent tether includes a first tether 200a that is extended toward the vent hole 120 from a front surface of the cushion 100 and a second tether 200b that is connected to a lower end of a rear surface of the cushion 100 from a front surface of the cushion 100 of the first tether 200a. Here, the first tether 200a and the second tether 200b are formed integrally to be connected at a front surface of the cushion 100.

Generally, a passenger P is moved toward a front surface of the deployed cushion 1 to compress the cushion 100 due to his/her inertia when a vehicle collides and the left and right lengths of the cushion 100 are decreased. As a result, a length b of the second tether 200b is decreased inevitably when the passenger P compresses the cushion 100.

Here, the length of the first tether 200a cannot be decreased since the left and right sides of the cushion 100 are inflated as a front surface of the cushion 100 is compressed, and further the second tether 200b a length of which is decreased sufficiently is slid upward through the tether guide 140 to amend the length a of the first tether 200a and ensure extra length of the first tether 200a.

As a result, the length of the first tether 200a is decreased smoothly to reduce the tension force such that the vent screen 300 opens the vent hole 120 for the gas inside the cushion 100 to be discharged, thereby controlling smoothly the pressure of the cushion.

As described above, the vent tether 200 is configured to be slid through the tether guide 140 and thus tension is given to the vent tether 200 when the cushion 100 is deployed such that the vent hole 120 is closed by the vent screen 300, and the tension force of the vent tether 200 is decreased smoothly when the cushion 100 is compressed by the passenger P such that the closed vent hole 120 is opened thereby to control properly the gas inside the cushion.

The vent screen 300 may be provided to a rear end of the vent tether 200, which is extended rearward, passes over the vent hole 120, and is connected to a rear of the vent hole 120. The vent screen 300 has such an area to cover the vent hole 120 and to close off the vent hole 120 wherein the vent screen 300 is folded on a rear of the vent hole 120 at an initial stage when the cushion 100 is not deployed.

The folded vent screen 300 is unfolded frontward as the cushion 100 is deployed and pulled toward a front to cover and close off the vent hole 120 so that the pressure inside the cushion 100 becomes high and the cushion 100 is deployed promptly to protect a passenger P from impact.

As described above, a front surface of the deployed cushion 100 is compressed by the passenger P to push rearward the vent tether 200, and thus the tension force which has pulled the tether frontward is reduced so that the vent screen 300 that covers the vent hole 120 is separated by the gas discharged through the vent hole 120.

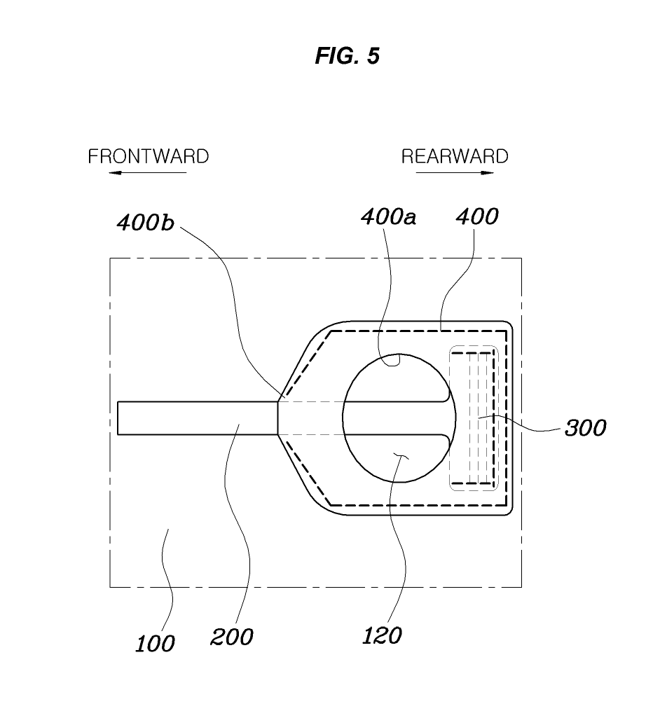

Describing the operation of the vent screen 300, referring to FIGS. 5 to 7, the vent screen 300 is installed on a rear of the vent hole 120 in a folding state and at this time the vent hole 120 is kept in an opening state, as shown in FIG. 5.

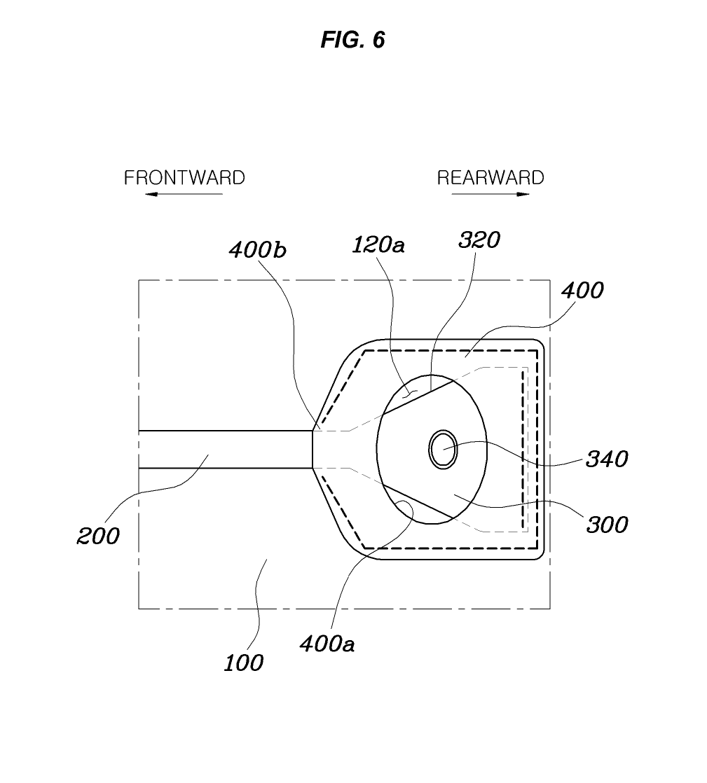

Under this condition, as the cushion 100 is deployed, as shown in FIG. 6, the vent screen 300 is unfolded frontward to cover the vent hole 120 and thereby to block a discharge of the gas, increasing rapidly the internal pressure of the cushion 100.

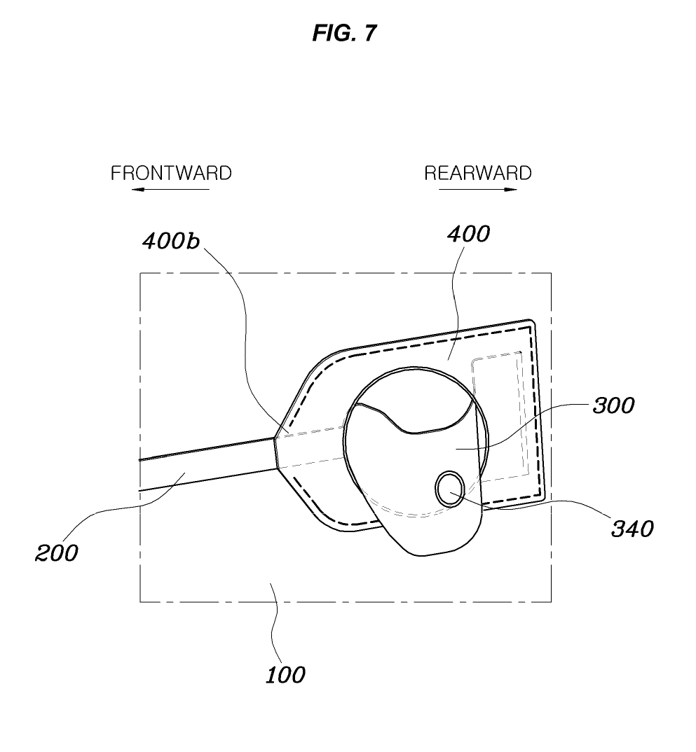

Meanwhile, the passenger P compresses a front of the cushion 100 while the cushion 100 is deployed to protect the passenger P from impact and thus the tension force of the vent tether 200 is reduced and the gas inside the cushion 100 is discharged through the vent hole 120, thereby separating the vent screen 300 from the vent hole 120, as shown in FIG. 7. As a result, the gas inside the cushion 100 is discharged outside to reduce the internal pressure thereof.

The gas inside the cushion 100 is discharged outside through the operation of the vent screen 300 to reduce the internal pressure thereof such that damage to the cushion 100 can be prevented due to its excessive internal pressure of the cushion 100 and secondary injury to the passenger due to a deployment force of the cushion can be prevented.

The respective configurations of the airbag device according to the present invention will be described below in detail, referring to the drawings.

As shown in FIG. 5, a screen guide 400 may be formed at a perimeter of the vent hole 120 in the cushion 100 to fix the vent tether 200 so as not to be moved in other directions except for a front/rearward direction.

That is, the screen guide 400 of the present invention guides the vent tether 200 to be moved only front/rearward, such that the vent screen 300 is unfolded toward a front of the cushion when the cushion 100 is deployed. In detail, the vent screen 300 is connected to a rear side of the vent hole 120 and the vent tether 200 is connected to a front side of the vent screen such that the vent screen is pulled by the vent tether 200 to be unfolded to a front when the cushion 100 is deployed. However, even though the vent screen 300 is unfolded to a front, when the vent screen is not disposed at the vent hole 120, the gas cannot be blocked efficiently.

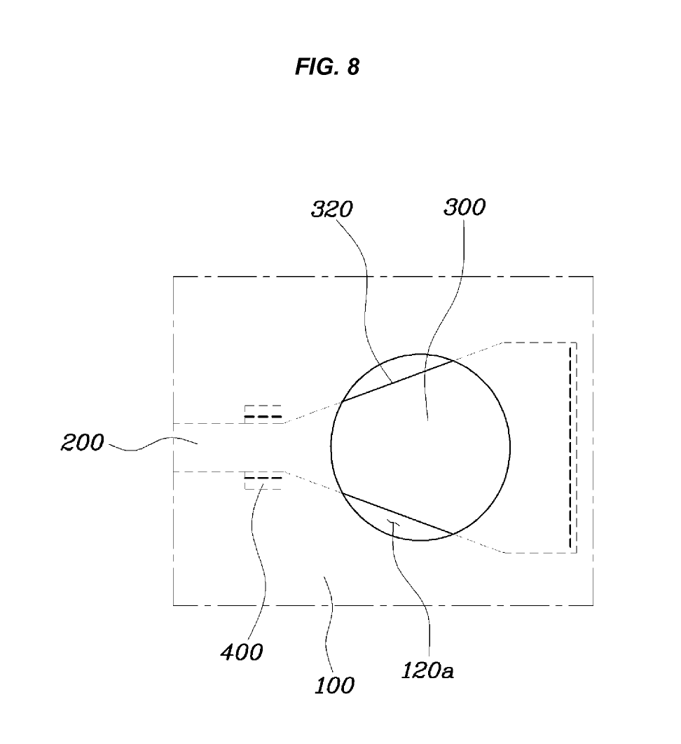

In order to block the gas efficiently, the vent tether 200 is restricted to be moved to other directions except for the front/rear directions such that the vent screen 300 is to be unfolded to a front by the vent tether that is pulled frontward when the cushion 100 is deployed. Here, the screen guide 400 may be arranged on a front of the vent hole 120 to fix the vent tether 200, as shown in FIG. 8.

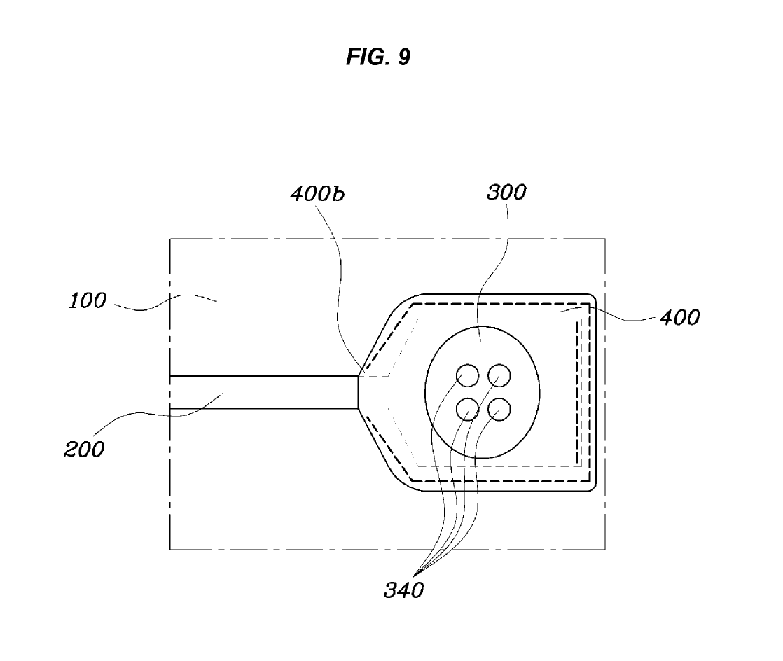

Meanwhile, the screen guide may be provided to cover the vent hole 120 and the vent screen 300 according to various embodiments of the present invention, as shown in FIG. 6 or 9, wherein a hole 400 having the same diameter as the vent hole 120 is formed and a front end is opened 400b for the vent tether 200 to be moved front/rearward.

As described above, the screen guide 400 that is shaped to cover the vent hole 120 and the vent screen 300 is connected to the cushion 100 together with the vent screen 300 to improve the connection force of the vent screen 300.

Furthermore, the screen guide 400 is sewed to enclose a perimeter of the vent hole 120 and is fixed firmly to the cushion 100, and as a result the screen guide 400 is not to be separated from the cushion 100 by operation of the vent tether 200 that is moved to other directions except for front/rear directions as the cushion 100 is deployed.

However, the screen guide 400 is formed to cover the vent hole 120 and the vent screen 300 wherein the hole 400a having the same or substantially the same diameter as the vent hole 120 is formed not to block the discharge of the gas, and further, a front part of the screen guide is not connected to the cushion 100 such that the front end 400b is opened for the vent tether 200 to be moved front/rearward. The screen guide 400 as described above may be shaped variously in practical applications.

Meanwhile, a front end of the vent tether 200 may be connected to an upper front surface of the cushion 100 such that the vent tether corresponds to the head of the passenger P when the cushion 100 is deployed.

Generally, the passenger P wears a safety belt, and thus the upper body of the passenger P is moved toward the cushion 100 when a vehicle collides. Especially, the waist of the passenger P is supported by the safety belt and thus the head of the passenger P is moved further toward the cushion 100 when a vehicle collides.

That is, the head of the passenger P compresses the cushion 100 when a vehicle collides wherein a front end of the vent tether 200 is connected to an upper front of the cushion 100 to correspond to the head of the passenger P so that the tension force of the vent tether 200 is reduced instantly when the head of the passenger P compresses the cushion during a vehicle collision.

As described above, as the head of the passenger P contacts first the cushion 100 and compresses the cushion to reduce instantly the tension force of the vent tether 200, the vent screen 300 is separated from the vent hole 120 through pressure of the discharging gas to ensure a channel through which the gas can be discharged. As a result, the gas inside the cushion 100 is discharged promptly to prevent the secondary injury to the passenger P due to the cushion 100 of a high pressure.

Meanwhile, as shown in FIG. 5, a width of the vent tether 200 is narrower than that of the vent screen 300 such that even when the vent tether 200 is disposed within the vent hole 120 while the vent screen 300 is folded, a discharging space for the gas can be ensured.

According to various embodiments of the airbag device of the present invention, the internal pressure of the cushion 100 can be controlled efficiently with opening/closing selectively the vent hole 120 through the vent screen 300 to dampen at a maximum level the impact applied to a passenger P. Further, in order to improve LRD performance of an airbag, when the cushion 100 is deployed while the passenger P sits on a place adjacent to the cushion, the internal gas of the cushion has to be discharged promptly to reduce the impact due to the deployment of the cushion 100.

For this purpose, according to various embodiments of the airbag device of the present invention, a width of the vent tether 200 is narrower than that of the vent screen 300, such that the vent tether 200 is to be disposed within the vent hole 120 while the cushion 100 is not deployed at an initial state, so as not to block a gas channel of the vent hole 120.

As described above, since the width of the vent tether 200 is formed to be relatively narrower, the vent hole 120 is opened even when the vent screen 300 is folded at an initial state, to ensure the discharging space for the gas. As a result, when the cushion 100 is in contact with the passenger P and compressed while the cushion 100 is deployed at an initial state, the internal gas of the cushion 100 is discharged instantly through the vent hole 120 to reduce the deployment force of the cushion 100.

As a result, a degree of the injury to the passenger P, which may be caused from a collision with the cushion when the cushion 100 is deployed at an initial state, can be minimized to prevent an accident caused from the deployment of the cushion 100.

Meanwhile, the vent screen 300 may be folded in a zigzag type so as to be folded temporarily. The vent screen 300 of the present invention may be formed to have such an area to cover the vent hole 120, kept in a folding state not to close the vent hole 120 before the cushion 100 is deployed, and unfolded toward a front of the vent hole 120 from a rear thereof when the cushion 100 is deployed to cover the vent hole 120.

The vent screen 300 may be folded in many different types or shapes. For instance, it may be folded in a type or shape to have such a predetermined area to cover the vent hole 120 wherein the vent screen may be folded in a zigzag type or shape on a rear of the vent hole 120 and then both ends thereof are bonded. Here, the both ends of the vent screen 300 may be bonded to be torn down easily with the pulling tension force of the vent tether 200 such that the vent screen 300 is to be deployed instantly when the cushion 100 is deployed.

Meanwhile, the vent screen 300 may be inclined toward a center from a rear side to a front side such that a gap 120a is formed between an inclined portion 320 and the vent hole 120 when the screen is unfolded to a front to cover the vent hole 120.

As shown in FIGS. 6 to 8, the vent screen 300 is formed as a triangle shape wherein it is inclined toward a center from a rear side of the vent hole 120 to a front side thereof, and thus the gap 120a is formed between the inclined portion 320 and the vent hole 120 when the vent screen 300 is unfolded frontward to cover the vent hole 120.

As described above, the gap 120a through which gas can be discharged is ensured between the vent screen 300 and the vent hole 120 and the gas is discharged through the gap 120a when the cushion is deployed, and thus the pressure of the internal gas of the cushion can be controlled to prevent damage to the cushion due to excessive internal pressure of the cushion 100 and minimize the injury to the passenger P due to the deployment pressure of the cushion 100.

According to various embodiments of the airbag device of present invention, a through hole 340 may be formed corresponding to the vent hole 120 while the vent screen 300 is unfolded to a front in order to control the internal pressure of the cushion. Here, the through hole 340 formed in the vent screen 300 may be formed to include a plurality of through holes within a diameter or the periphery of the vent hole 120.

As shown in FIGS. 6 to 9, the through hole 340 is formed substantially at a center of the vent screen 300 corresponding to the vent hole 120, and the internal gas is to be discharged outside through the through hole 340 even though the vent screen 300 closes off the vent hole 120 when the cushion 100 is deployed to control the pressure of the cushion 100, thereby preventing excessive pressure induced in the cushion 100. Here, the through hole 340 is formed through the vent screen 300 to include a plurality of through holes within a diameter or the periphery of the vent hole 120 to control properly the internal pressure of the cushion 100 corresponding to a specification of the airbag.

As described above, the through hole 340 is formed through the vent screen 300 corresponding to the vent hole 120 and the internal gas of the cushion 100 is to be discharged outside through the through hole to prevent damage to the cushion 100 which may be caused from excessive internal pressure of the cushion 100.

According to various embodiments of an airbag of the present invention, the vent hole 120 is to be opened when the cushion 100 is deployed at an initial state to maximize the discharging amount of the internal gas of the cushion, thereby preventing injury to a passenger due to excessive deployment force of the cushion. Additionally, the vent hole 120 is to be closed when the cushion 100 is deployed fully to keep a constant pressure inside the cushion thereby to dampen the pressure applied to the passenger P. Furthermore, the vent hole 120 is to be opened when the airbag is compressed by the passenger P to prevent secondary injury to the passenger P which may be caused from the airbag.

Meanwhile, according to various embodiments of the airbag of the present invention, the internal pressure of the cushion 100 can be prevented being induced excessively through the vent screen 300 and the vent hole 120 to prevent damage to the cushion 100. Further, the vent hole 120 can be opened or closed simply to reduce cost without separate devices for opening/closing the vent hole.

For convenience in explanation and accurate definition in the appended claims, the terms “upper” or “lower”, “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

1. An airbag device, comprising:
a cushion each of both sides of which is formed with a vent hole through which introduced gas is discharged outside;
a first vent tether disposed at an upper side of the cushion, wherein a front end of the first vent tether is slidably connected to a front surface of the cushion and a rear portion of the first vent tether is extended toward the vent hole inside the cushion;
a second vent tether disposed at a lower side of the cushion, wherein a front end of the second vent tether is connected to the front end of the first vent tether and a rear end thereof is connected to a lower end in a rear surface of the cushion;
a vent screen which is extended from the first vent tether, connected to a rear of the vent hole and has a surface area for selectively covering the vent hole,
wherein the vent screen is initially folded and upon being pulled by the vent tether when the cushion is deployed, is unfolded frontward to cover and close the vent hole,
wherein a tension force of the vent tether is decreased when the deployed cushion is compressed by a passenger, thereby opening the vent hole to discharge the gas,
wherein a screen guide is formed at a perimeter of the vent hole in the cushion to fix the vent tether so as not to be moved to a direction other than a front/rearward direction, and
wherein the vent screen is temporarily folded in a zigzag shape.

2. (canceled)

3. The airbag device of claim 1, wherein the screen guide is formed to cover the vent hole and the vent screen wherein a hole having substantially a same diameter as the vent hole is formed and a front end thereof is opened for the vent tether to be moved in the front/rearward direction.

4. (canceled)

5. The airbag device of claim 4, wherein a tether guide to which the vent tether is connected slidably is provided to the front surface of the cushion and a length of the first and second vent tethers is controlled to vary as the first and second vent tethers are slid to the tether guide when the cushion is compressed after deployment.

6. The airbag device of claim 1, wherein a front end of the first vent tether is connected to an upper front of the cushion to correspond to a head of the passenger when the cushion is deployed.

7. The airbag device of claim 1, wherein a width of the first vent tether is narrower than that of the vent screen so that even when the first vent tether is disposed within the vent hole while the vent screen is folded, a discharging space for the gas is ensured.

8. (canceled)

9. The airbag device of claim 1, wherein the vent screen is inclined toward a center from a rear side to a front side so that a gap is formed between an inclined portion and the vent hole when the vent screen is unfolded frontward to cover the vent hole.

10. The airbag device of claim 1, wherein at least one through hole is formed corresponding to the vent hole when the vent screen is unfolded.

11. The airbag device of claim 10, wherein the at least one through hole formed in the vent screen includes a plurality of through holes within the periphery of the vent hole.
